(19) United States
(12) Patent Application Publication
(10) Pub. No.: US 2018/0150635 A1
(43) Pub. Date: May 31, 2018

(54) Apparatus and Method for Using a Support Vector Machine and Flow-Based Features to Detect Peer-to-Peer Botnet Traffic

(71) Applicant: The United States of America as represented by the Secretary of the Navy, San Diego, CA (US)

(72) Inventors: Sara E. Melvin, Oxnard, CA (US); Logan M. Straatemeier, San Diego, CA (US); Eric L. Dorman, San Diego, CA (US); Shibin Parameswaran, San Diego, CA (US)

(21) Appl. No.: 15/362,602

(22) Filed: Nov. 28, 2016

(51) Int. Cl. G06F 21/56; H04L 29/06; G06N 99/00

(52) U.S. Cl. CPC G06F 21/56; H04L 63/1425; G06F 2221/034; H04L 2463/144; G06N 99/005

(57) ABSTRACT

A method using behavior-based detection to detect and observe known malicious traffic on a virtual machine; parsing up the observed malicious traffic by flow features; using a machine learning algorithm to train a classifier that separates the features into a normal class and an abnormal class, wherein the abnormal class is malware; weighing the importance of the features, wherein importance is based on each feature's contribution to overall system performance; creating models using the classified normal and abnormal features; using these models to classify future observed traffic.

### FEDERALLY-SPONSORED RESEARCH AND DEVELOPMENT

The Method to Detect Peer-to-Peer Botnet Traffic Using the Support Vector Machine and Flow-Based Features is assigned to the United States Government and is available for licensing for commercial purposes. Licensing and technical inquiries may be directed to the Office of Research and Technical Applications, Space and Naval Warfare Systems Center, Pacific, Code 72120, San Diego, Calif., 92152; voice (619) 553-5118; email_ssc_pac_T2@navy.mil. Reference Navy Case Number 103745.

### BACKGROUND

A botnet is an organized network of machines compromised by malware, and is often used to conduct distributed denial of service (DDOS) attacks, spreading electronic spam, conducting click-fraud scams, and stealing personal user information. An attacker known as a botmaster or botherder takes control of infected machines by issuing commands through a Command and Control (C2) system. Given that the C2 system is one of the most critical parts of a botnet, obscuring this C2 system is one of the primary focus areas for botnet development. Structuring the botnet in a peer-to-peer (P2P) manner causes botnets to become more sophisticated and surreptitious. Instead of communicating with a central C2 server, P2P botnet members, known as bots, are associated with only a handful of infected “neighbor” computers in the network, making the task of identifying all bots in P2P networks difficult. Since each member of a botnet P2P group only knows a few other members, the failure of one agent does not mean that the whole group is disclosed. Additionally, each member in the group communicates to one another using encrypted C2 protocols, making it difficult to distinguish the malicious traffic from normal encrypted Internet traffic. These attributes contribute towards the resilience of P2P botnets. A need exists to be able to detect unknown botnets or variants of known malware.

There are many existing techniques to detect this type of malicious traffic, and they generally fall into two categories: signature-based detection and behavior-based detection. The method described herein uses behavior-based detection focusing on modeling normal traffic and detecting deviations. The method described herein evaluates a set of features related to traffic or packet flow called flow features, in conjunction with a machine learning algorithm, to detect multiple types of P2P botnets embedded in other encrypted P2P traffic. Flow features extracted from individual sessions between a source-destination pair isolates conversations from one another, keeps compromised traffic from being masked by normal traffic, and aids in identifying other compromised hosts.

### BRIEF DESCRIPTION OF THE DRAWINGS

FIG. 1 shows an exemplary monitoring system in accordance with the Method to Detect Peer-to-Peer Botnet Traffic Using the Support Vector Machine and Flow-Based Features.

FIG. 2 shows a flow chart demonstrating the method to detect peer-to-peer botnet traffic using the support vector machine and flow-based features.

FIG. 3 shows a flowchart demonstrating feature extraction using flow in accordance with the Method to Detect Peer-to-Peer Botnet Traffic Using the Support Vector Machine and Flow-Based Features.

FIG. 4 shows a system for detecting malware in accordance with the Method to Detect Peer-to-Peer Botnet Traffic Using the Support Vector Machine and Flow-Based Features.

FIGS. 5a and 5b demonstrate how a linear boundary can be created with complex data by projecting it to a higher dimensional space.

### DETAILED DESCRIPTION OF SOME EMBODIMENTS

Reference in the specification to “one embodiment” or to “an embodiment” means that a particular element, feature, structure, or characteristic described in connection with the embodiments is included in at least one embodiment. The appearances of the phrases “in one embodiment”, “in some embodiments”, and “in other embodiments” in various places in the specification are not necessarily all referring to the same embodiment or the same set of embodiments.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or.

Additionally, use of the “a” or “an” are employed to describe elements and components of the embodiments herein. This is done merely for convenience and to give a general sense of the invention. This detailed description should be read to include one or at least one and the singular also includes the plural unless it is obviously meant otherwise.

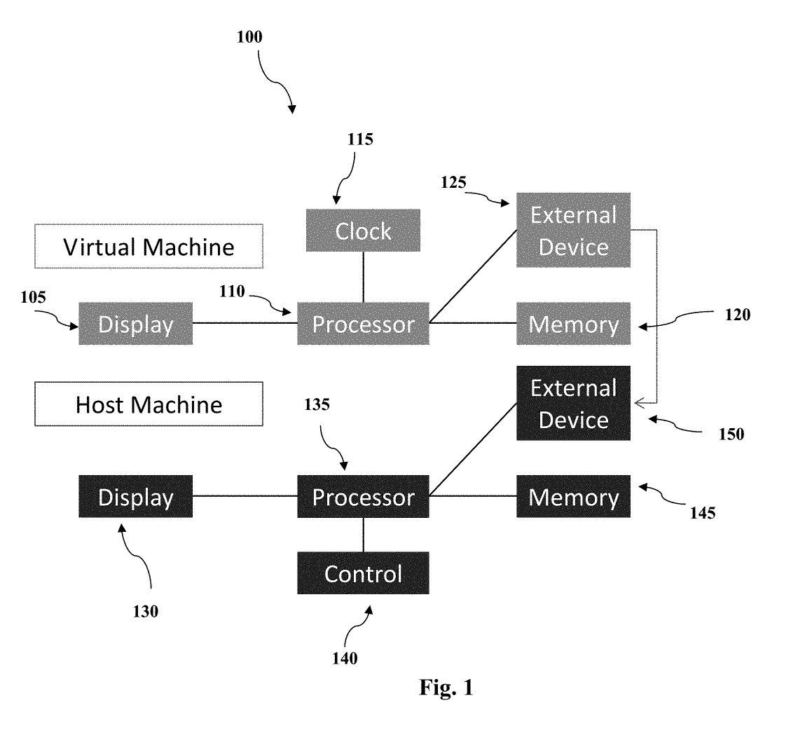

FIG. 1 shows an exemplary monitoring system 100 for monitoring a plurality of separate parameters to which sensitive items are sensitive. System 100 comprises a Virtual Machine (VM) display 105, VM processor 110, VM clock 115, VM memory 120, external device 125, a Host Machine (HM) display 130, HM processor 135, HM control 140, HM memory 145, and HM external device 150. The exemplary VM components 105-125 create an input for an exemplary sensor software and system that executes the sensor software. These components can be used to record network traffic and store this network traffic data in external device 125. VM display 105 displays a graphical user interface (GUI) of the VM. VM clock 115 records a time stamp of recorded network traffic data. VM memory 120 and VM processor 110 can execute traffic recording software (for example, Wireshark). External device 125 stores recorded network traffic as input data from the VM to be utilized by the sensor software located in the host machine control 140. Host machine processor 135 and memory 145 execute the sensor software. HM display 130 exhibits a graphical user interface of the sensor software system values.

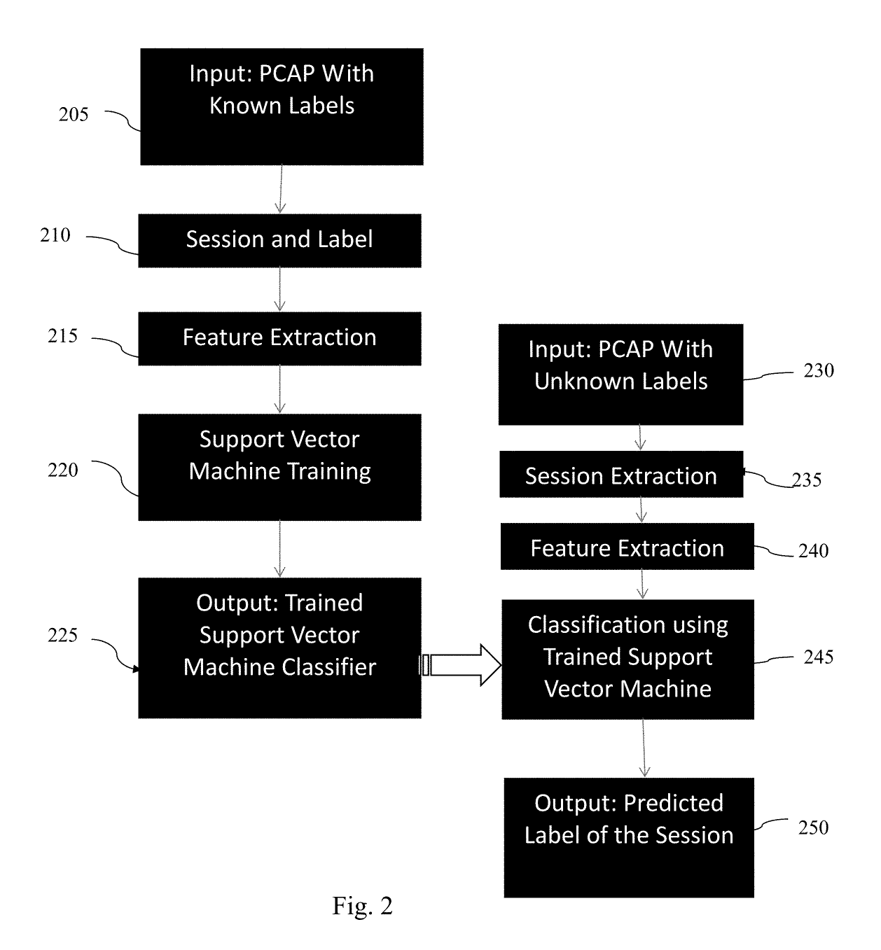

FIG. 2 shows one exemplary methodology of the sensor software located within the HM control 140. FIG. 2 shows a flow chart 200 of exemplary sensor software. As described in details below, flow chart 200 is executed in the system in two parts: training of a hyperplane (aka classifier) 220 and classifying observed traffic shown in Input-PCAP 235.

First, a classifier must be trained using a labeled data set. Network traffic having known labels is stored in a packet capture (PCAP) file 205 and inputted in the software. This input/PCAP file 205 can then be parsed up into sessions 210 where header fields of each packet in the session are printed in a text file. A session can be defined as a TCP session.

Once the input/PCAP file with known labels 205 is parsed into sessions 210, a select set of features 215 are extracted and calculated from these sessions. Next, a Support Vector Machine (SVM) Classifier 220 is trained, which learns a maximally separating hyperplane that separates two different categories in the labeled data set: botnet traffic and normal traffic. The learned hyperplane is the output 225 of the training process, and is then saved for later use. The SVM Classifier 220 separates the two categories by solving the following:

Subject to:

To test a classification of observed network traffic, detected traffic is inputted in as a PCAP file with unknown labels 230, parsed into sessions 235, and features 240 are extracted and calculated. This classification using the trained SVM 245 hyperplane results in the Output 250, and thus are used to predict the label of the session.

The Support Vector Machine (SVM) is one of the most successful and widely used classification algorithms. SVMs are binary classifiers by nature; however they can be applied to multiclass classification problems by one-vs-one or one-vs-all strategies. In a two-class scenario, given the training data and class labels, an SVM learns a hyperplane that separates the two classes and has the largest margin from the nearest training sample from either of the classes. This makes the SVM a linear classifier which can be a limitation when used to classify data since the data may not be linearly separable. For this reason, SVMs are often used with kernel functions that map input data to higher (possibly infinite) dimensional feature space. Using this method, usually referred to as the “kernel trick,” SVMs can learn highly non-linear boundaries in the original input feature space. An experiment was conducted with linear SVMs and SVMs with radial basis function (RBF) kernels (Gaussian kernels). The analysis focuses on testing the ability of flow features to discriminate between different botnets, and the applicability of such features in different detection scenarios. Therefore, instead of searching for the best classifier parameters for each of the tasks and for each botnet, parameter settings were identified that performed well for all tasks and held these constant in all experiments.

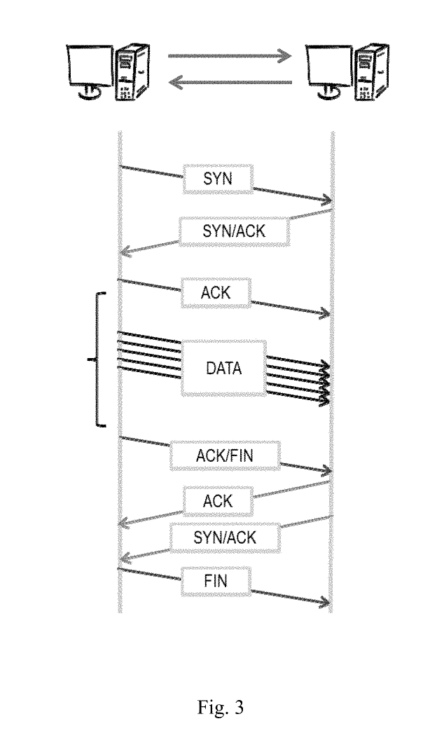

FIG. 3 shows a flowchart 300 demonstrating feature extraction using flow, where flow is a sequence of packets from a source to a destination (within a certain time period). The particular features extracted are the size of the largest packets in a flow, the total bytes transferred with largest packets in a flow, the ratio of largest packets in a flow, the average inter-arrival time between packets in a flow, the variance of inter-arrival time between packets in a flow, the average size of packet in a flow, the variance of pocket sizes in a flow, and the number of packets per flow.

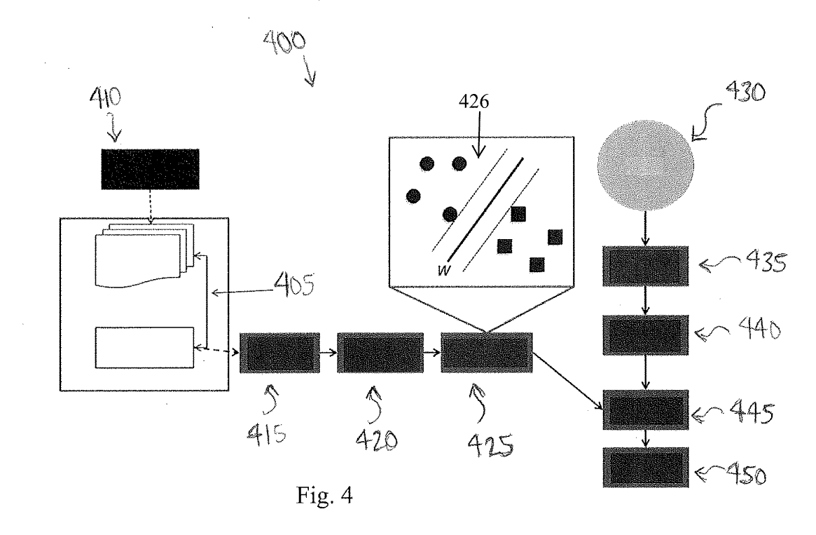

FIG. 4 shows a system 400 for detecting malware in accordance with the Method to Detect Peer-to-Peer Botnet Traffic Using the Support Vector Machine and Flow-Based Features. System 400 comprises a virtual network 405 that further comprises blacklist URLs 410 that exhibit known malware. Blacklist URLs 410 will help to build models of what is already known as a bad pattern or malware, so that they can be used for detection later on. System 400 further comprises a flow extractor 415, and a feature extractor 420, followed by a Support Vector Machine (SVM) 425. SVM 425 will help to differentiate between normal conversation and bad conversation, or malware, as is demonstrated by boundaries 426 above SVM 425. System 400 further comprises a user 430. User 430 further comprises a flow extractor 435, a feature extractor 440, a mechanism for analysis 445 and for classification 450.

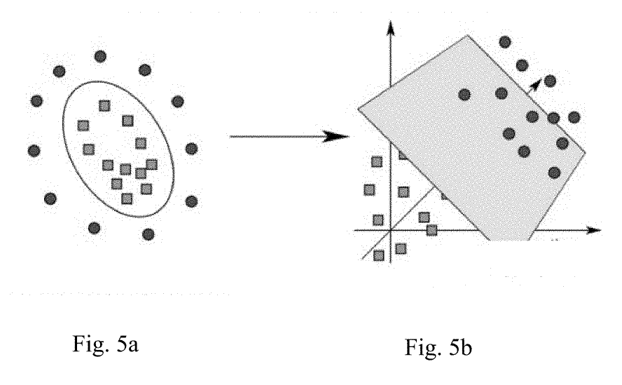

Occasionally, real world data is not always linearly separable by a classifier or hyperplane. This presents a challenge to linear classifiers such as the Support Vector Machines to separate data reliably. However, as mentioned earlier, by mapping the low dimensional data onto a space of sufficiently higher dimension, a linear separation between the competing classes can be found and therefore can be separated using a hyperplane. FIG. 5a shows complex data in low dimensions, and FIG. 5b shows that complex data being turned into separable data in a higher dimension, or an infinite dimensional space produced by the RBF kernels, where it can be separated and used in a hyperplane.

The performance of flow-based features was evaluated in botnet detection and classification using linear SVM and SVM with RBF kernels. The flow features were extracted from PCAP files of normal P2P traffic and three different families of botnets namely Zeus, Conficker, and Sendori. Thus, the extracted flow feature vectors belong to four different classes and the dataset is comprised of 349, 732, 629 and 638 individual flows from normal, Zeus, Conficker and Sendori traffic respectively. In order to facilitate learning of an unbiased classifier, the data was divided from each of the four classes into two disjoint sets—one containing 80% of the data which was to be used for training and the remaining 20% to be used as testing data. The assumption is that training data is only accessible during the classifier learning stages. Therefore, the feature mean and variance, used for feature normalization during both training and testing stages, were calculated using only the training data (consisting of both normal and botnet training samples). To ensure objectivity, ten random 80/20 splits of data was generated and the results were averaged over all of the different iterations.

The linear SVM performed poorly in distinguishing between the flows containing normal P2P traffic from botnet traffic. It falsely labeled a large percentage of normal traffic as malicious, thus resulting in a high false positive rate. In contrast, the RBF-SVM provided much better classification performance. The average accuracies (mean of the diagonal elements in a confusion matrix) obtained by RBF-SVM on the simple single bot detection experiments with Zeus, Sendori, and Conficker bot varieties are 90.32%, 94.01% and 82.57% respectively.

Our results suggest that flow features can be used to detect and classify multiple botnets when used with a strong classifier. Future work will focus on identifying more discriminatory features to reduce the dependence on strong (computationally expensive) classifiers. We will also investigate employing online learning methods to adapt learned classifiers to successfully detect botnets as their activity profiles vary over time.

This methodology could be also used for general traffic fingerprinting for verification of websites legitimacy. This verification is important because cybercriminals will create webpages that look almost identical to another website, such as a banking website, and will use this malicious website to lure victims to give up their username, password, SSN, etc.

The method described herein demonstrates that flow features can be used to detect and classify multiple botnets when used with a strong classifier. This methodology could be also used for general traffic fingerprinting for verification of websites legitimacy. This verification is important because cybercriminals will create webpages that look almost identical to another website, such as a banking website, and will use this malicious website to lure victims to give up their username, password, SSN, etc.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method comprising the following steps:
using behavior-based detection to detect and observe known malicious traffic on a virtual machine;
parsing up the observed malicious traffic by flow features;
using a machine learning algorithm to train a classifier that separates the features into a normal class and an abnormal class, wherein the abnormal class is malware;
weighing the importance of the features, wherein importance is based on each feature's contribution to overall system performance;
creating models using the classified normal and abnormal features;
using these models to classify future observed traffic.

2. The method of claim 1 wherein the known malicious traffic is detected in peer-to-peer (P2P) botnets.

3. The method of claim 2 wherein the machine learning algorithm used is a Support Vector Machine (SVM).

4. The method of claim 3 wherein the flows are classified using a SVM having a non-linear classifier.

5. The method of claim 4 wherein the classifier is a hyperplane.

6. The method of claim 5 wherein the hyperplane separation occurs in an infinite dimensional space produced by radial basis function (RBF) kernels where the features can be separated using a linear boundary.

7. The method of claim 6 wherein the traffic is encrypted.

8. The method of claim 1 wherein the features observed are network-based features.

9. The method of claim 1, wherein the features extracted include the following: the size of the largest packets in a flow, the total bytes transferred with the largest packet in a flow, the total bytes transferred in a flow, the ratio of largest packets in a flow, the average packet size in a flow, the variance of packet sizes in a flow, the average inter-arrival time between packets in a flow, the variance of inter-arrival time between packets in a flow, and the number of packets per flow.

10. A system comprising a first computer configured to host a virtual network, wherein the virtual network operates blacklist URLs exhibiting known malicious traffic having both normal and abnormal features, and wherein the virtual network is configured to extract the malicious traffic flow, parse the malicious traffic up by sessions, and isolate and extract the normal and abnormal features;
a machine learning algorithm configured to use the extracted features to train a model, wherein the model classifies future observed traffic;
a second computer having a user, wherein the user is configured to extract a general traffic flow, isolate and extract general traffic features, and compare the features with the models obtained from the first computer.

11. The system of claim 10 wherein the machine learning algorithm is a support vector machine (SVM).

12. The system of claim 11 wherein SVM comprises a non-linear classifier.

13. The system of claim 12 wherein the non-linear classifier comprises radial basis function kernels (RBF).

14. The system of claim 13 wherein the non-linear classifier is a hyperplane.

15. The system of claim 14 wherein the separating hyperplane is trained in the infinite dimensional space produced by radial basis function (RBF) kernels.

16. A method comprising the steps of:
storing network traffic in a packet capture (PCAP) file and inputting into software;
parsing up the PCAP file into sessions and labeling the sessions;
extracting and calculating a select set of features from the sessions;
training up an optimized classifier separating two different categories using a Support Vector Machine (SVM);
inputting detected traffic into a PCAP file, wherein the traffic is parsed into sessions and features are extracted and calculated; and
analyzing and classifying the sessions using the trained classifier.

17. The method of claim 16 further comprising the step of predicting the label of the analyzed sessions.
